(19) United States
(12) Patent Application Publication
(10) Pub. No.: US 2004/0200965 A1
(43) Pub. Date: Oct. 14, 2004

(54) Radiographic inspection apparatus and radiographic inspection method

(76) Inventors: Kikuo Umegaki, Hitachinaka (JP); Shinichi Kojima, Hitachi (JP); Yuuichirou Ueno, Hitachi (JP); Kensuke Amemiya, Hitachinaka (JP); Norihito Yanagita, Hitachi (JP); Hiroshi Kitaguchi, Naka (JP); Katsutoshi Tsuchiya, Hitachi (JP); Kazuma Yokoi, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 10/765,909

(22) Filed: Jan. 29, 2004

(30) Foreign Application Priority Data
Apr. 11, 2003 (JP) 2003-107197

(51) Int. Cl. G01T 1/161

(52) U.S. Cl. 250/363.1

(57) ABSTRACT

In a radiographic inspection device which can shorten the inspection time and which can enhance the spatial resolution of thus obtained image, has two first and second radiation detecting devices each of which comprises several radiation detectors, a collimator device and a collimator moving device. The collimator device incorporates grid-like shield members defining several γ ray passages. Each of the γ ray passages has a cross-sectional area which is greater than that of each of the radiation detectors. The collimator device in the first radiation detecting device is moved in the longitudinal direction through the rotation of a motor in the collimator moving device while the collimator device in the second radiation detecting device is moved in a direction orthogonal to the longitudinal direction through a motor in the collimator moving device. Since the cross-sectional area of the γ ray passage is greater than that of the radiation detector, the sensitivity of detection of γ rays as to the radiation detector is enhanced, thereby it is possible to greatly shorten the inspection time. Further, since the collimator devices are moved by the collimator moving devices, respectively, the spatial resolution by the tomogram can be enhance.

### BACKGROUND OF THE INVENTION

The present invention relates to a radiographic inspection apparatus and a radiographic inspection method, and in particular to a radiographic inspection apparatus and a radiographic inspection method which are preferably applied for a single photon emission computed tomography (which will be hereinbelow referred to as “SPECT”) and a digital radiography.

Inspections using radioactive rays have been used in a technology in which a function or a configuration in the human body of a person to be examined as an object to be tested is non-invasively imaged. Among then, there has been used, as a typical inspection method, the SPECT or the digital radiography using an ionizing radiation which can cause ionization.

The SPECT doses a radiopharmaceutical containing a single photon emission nuclide (⁹⁹Tc, ⁶⁷Ga, ²⁰¹Ta or the like) as a radionuclide and a substance having such a behavior that it accumulates to a specific neoplasm (cancer) or a specific molecule, such as glucose, into a person to be examined, and γ rays emitted from the radionuclide are detected by a radioactive ray detector. The energy of the γ rays emitted from the single photon emission nuclide which is frequently used for inspection by the SPECT is about several tens KeV to several hundreds KeV. In the case of the SPECT, since a single γ ray is emitted, the γ ray incident upon a radiation detector cannot exhibit information as to an angle. Thus, angle data is obtained by detecting only γ rays which are incident upon the radiation detector, having a specific angle, with the use of a collimator. The SPECT is such an inspection method that γ rays which have been emitted from the single photon emission nuclide contained in the radiopharmaceutical accumulated in the affected part in a person to be examined, and which come out from the human body of the person to be examined, are detected by the radiation detector so as to specify a place where the radiopharmaceutical is consumed by a large quantity. ⁹⁹Tc, ⁶⁷Ga and ²⁰¹Ta used in the SPECT have a half value period which is in a range between six hours and three days. There are used technetium phosphate for inspecting a cancerous lesion which has been transferred to a bone, sodium iodide used for thyroid inspection and the like as typical examples of radiopharmaceuticals.

In general, in X-ray illumination, X-rays transmitted through the human body is exposed to a film so as to intensities of transmitted X-rays. On the contrary, in digital radiography (digital X-ray inspection apparatus), intensities of X-rays transmitted through a person to be examined are measured with the use of a flat panel detector in which radiation detectors are arranged in an array, instead of the film. The digital radiography can digitally store intensities of transmitted X-rays and can carry out image processing in comparison with a conventional X-ray photograph.

For example, JP-A-2000-180551 discloses a radiation detecting device used in the SPECT and the digital radiography. In this radiation detecting device, a collimator is arranged in front of several scintillators (radiation detectors) arrayed in X- and Y-axial directions. The collimator has γ ray passages (through-holes) through which γ rays pass and which has a size equal to that of the radiation detectors.

The above-mentioned radiation detecting device detects γ rays in a specific direction defined by the collimator. That is, several γ rays are shielded off by the collimator. However, should the size of the γ ray passages (through-holes) which are formed in the collimator and through which γ rays pass be increased, in order to reduce the volume of the γ rays blocked, the spatial resolution of an image created by detection signals for the γ rays would be lowered. The radiation detecting device as disclosed in JP-A-2000-180551 utilizes a collimator in which the size of the γ ray passages is equal to that of the radiation detectors. However, even with the use of such a collimator, the detection sensitivity of γ rays cannot be enhanced in the radiation detectors.

### BRIEF DESCRIPTIONS OF THE INVENTION

An object of the present invention is to provide a radiographic inspection apparatus and a radiographic inspection method which can shorten the inspection time and which can enhance the spatial resolution of an obtained image.

To the end, the present invention is characterized in that each of a plurality of radiation passages formed in a collimator device has a cross-sectional area in a direction crossing the center axis of the radiation passage which is greater than a cross-sectional area of the radiation detector in that direction, and either a plurality of radiation detectors or the collimator device are displaced in the crossing direction.

Since the cross-sectional area of each of the radiation passages formed in the collimator device is larger than the cross-sectional area of the radiation detector in that direction, γ rays incident upon each of the radiation detectors are increased. Accordingly, the detection sensitivity of radiation in the radiation detector is increased, and accordingly, the inspection time for a human body to be examined can be greatly shortened. Further, since the plurality of radiation detectors or the collimator device are displaced in the crossing direction, the spatial resolution of a tomogram created by data which is obtained from radiation detecting signals delivered from the respective radiation detectors can be enhanced.

Other objects, features and advantages of the invention will become apparent from the following description of the embodiments of the invention taken in conjunction with the accompanying drawings.

### BRIEF DESCRIPTION OF SEVERAL VIEWS OF THE DRAWING

FIGS. 1A to 1C are views for explaining a concept of displacement of a collimator according to the present invention, among which,

FIG. 1A is a view for explaining a first state of the collimator,

FIG. 1B is a view for explaining a second state of the collimator in which the collimator is displaced in the X-axial direction from the first state by a distance corresponding to one radiation detector, and

FIG. 1C is a view for explaining a third state in which the collimator is displaced in the Y-axial direction from the second state by a distance corresponding to one radiation detector;

FIGS. 2A to 2C are views for explaining a condition in which γ rays emitted from a γ ray source pass through γ ray passages in the collimator, among which

FIG. 2A is a view for explaining conditions in which the γ rays pass through the γ ray passages in the first state shown in FIG. 1A,

FIG. 2B is a view for explaining a condition in which the γ rays pass through the γ ray passages in the second state shown in FIG. 1B, and

FIG. 2C is a view for explaining a condition in which γ rays pass through γ ray passages in a conventional collimator;

FIG. 3 is a view for explaining a concept of voxels;

FIG. 4 is a view illustrating a configuration of a radiographic inspection apparatus in a preferred embodiment of the present invention;

FIG. 5 is a sectional view along line V-V in FIG. 4;

FIG. 6 is a perspective view illustrating a collimator device shown in FIG. 4;

FIG. 7 is a flow-chart for explaining process steps for creating a tomogram;

FIG. 8 is a view for explaining calculation of a probability of incidence upon radiation detectors for γ rays;

FIG. 9 is a view for configuration of a radiographic inspection apparatus in another embodiment of the present invention;

FIG. 10 is a perspective view illustrating a collimator device shown in FIG. 9;

FIGS. 11A to 11C are views for explaining states of displacements of the collimator device shown in FIG. 9, among which

FIG. 11A is a view for explaining a first displacement state of the collimator device, and

FIG. 11B is a view for explaining a second displacement state of the collimator device after rotation; and

FIG. 11C is a view for explaining a second state of the collimator state of the collimator device after rotation;

FIG. 12A to 12B are views for explaining conditions in which γ rays pass through the collimator device, among which,

FIG. 12A is a view for explaining a condition in which the γ rays pass through the collimator device in the first state shown in FIG. 11A, and

FIG. 12B is a view for explaining a condition in which the γ rays pass through the collimator device in the second state shown in FIG. 11B.

### DESCRIPTION OF PREFERRED EMBODIMENTS OF THE INVENTION

The inventors have considered various ideas for attaining both shortening of an inspection time or enhancement of sensitivity of detection of γ-rays (arrival probability of γ-rays at a radiation detector) and enhancement of a spatial resolution of an image, which are tasks contrary to each other. As a result, the inventors have found that these contrary tasks can be attained by changing with time the relative positional relationship between a collimator having a plurality of γ-ray passages each having a cross-sectional area which is greater than that of each of the radiation detectors, and the radiation detectors.

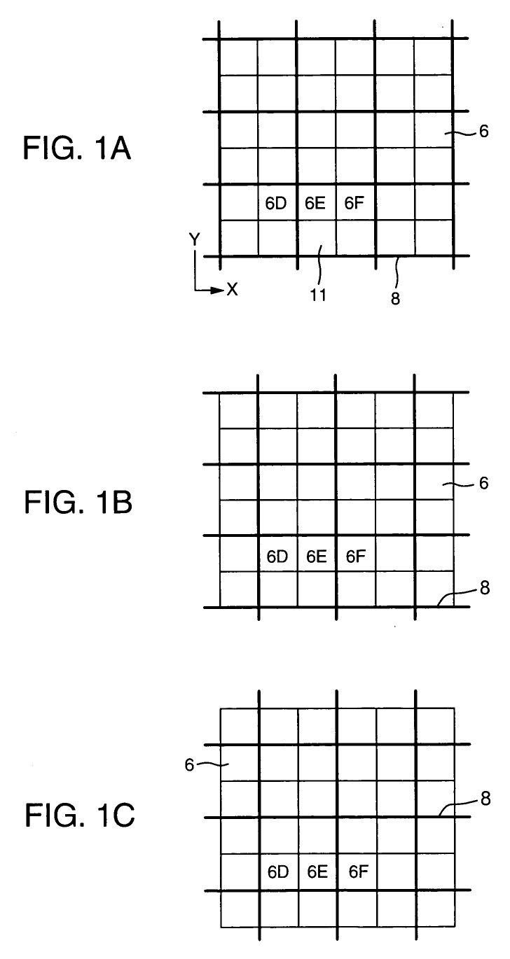

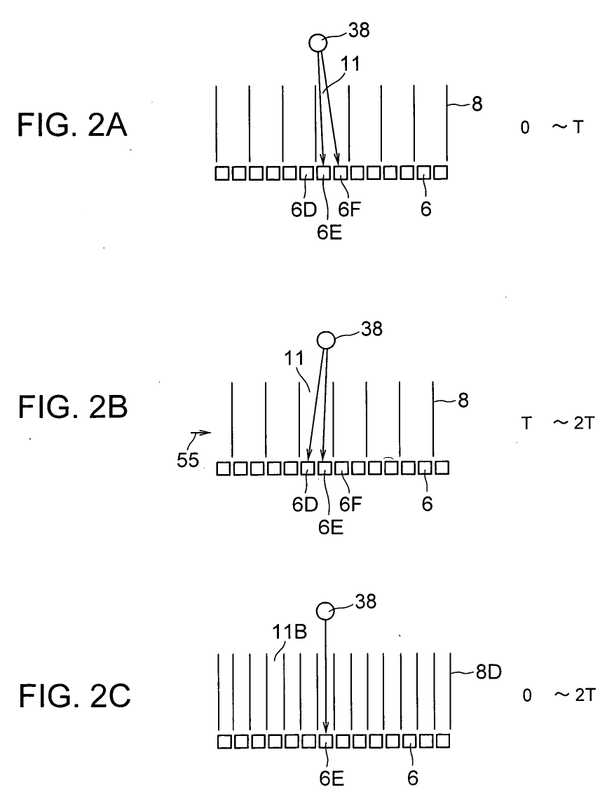

Explanation will be herfeinbelow made of a basic concept of the present invention which can attain both tasks with a specific instance shown in FIGS. 1A to 2C. FIGS. 1A to 1C typically show a positional relationship between, for example, within a 6-row and 6-column array in which 36 radiation detectors 6 are arranged, the radiation detectors 6 and the shield members 8 in the collimator, as viewed from the shield member 8 side. The grid-like shield members 8 made of a radiation shield material. The grid-like shield members 8 can form a plurality of γ-ray passages 11 each having a cross-sectional area greater than that of each of the radiation detectors 6, the widths thereof in both X-axial direction (the longitudinal direction of a head 26 which will be described later) and the Y-axial direction (the direction orthogonal to the longitudinal direction of the head) each corresponding to a value twice as large as the width of each of radiation detectors. The cross-sectional area of each of the γ-ray passages 11 is substantially equal to a value corresponding to four cross-sectional areas of the radiation detectors 6 arranged in a square shape. These shield members 8 are displaced in the X-axial direction from a state shown in FIG. 1A by a distance corresponding to the width of one radiation detector 6 (Refer to FIG. 1B). Thereafter, the shield members 8 are displaced in the Y-axial direction by a distance corresponding to one radiation detector (Refer to FIG. 1C). With states shown in FIGS. 1A, 1B and 1C, γ-rays emitted from a person to be examined to whom a radiopharmaceutical has been dosed are successively detected by the radiation detectors 6 at set time intervals.

An increase in the sensitivity of detection of γ-rays in at the shield members 8, that is, an increase in the number of γ-rays which are detected by a single radiation detector 6 will be verified. In order to simplify this problem, it is estimated that a γ-ray source 38 and the collimator is one-dimensionally arranged, an increase in the number of γ-rays detected by the radiation detector 6 will be considered in the present invention. In this case, if an N number of γ-rays which can be incident upon one radiation detector in a statistically long time that is, in a time T (sec) are produced per solid angle, γ-rays are incident upon the radiation detector 6E by a number N, at every T sec in grid-like shield members 8D (shown in FIG. 2C) in a conventional collimator. The cross-sectional area of each of the γ-ray passages defined by the shield members 8D is substantially equal to that of the single radiation detector. Accordingly, with the shield members 8D, the γ-rays are incident upon the radiation detector 6E by a number of about 2N within a time of 0 to 2T sec. It is noted here that the γ-ray source 38 is a single photon emission nuclide contained in a radiopharmaceutical accumulated in an affected part.

The collimator constituted by the shield members 8 having γ-ray passages each having a large cross-sectional area is not fine in comparison with the collimator constituted by the shield members 8D.

After the positional relationship between the shield members 8 and the radiation detectors comes into a condition shown in FIG. 2A (the state shown in FIG. 1A), γ-rays emitted from the γ-ray source 38 are incident upon radiation detectors 6E, 6F facing one of the γ-ray passages 11 by a number of about N, respectively thereto within a time from 0 to T sec. After T sec. elapses, the shield members 8 are displaced in the direction of the arrow 55 (X-axial direction) by a distance corresponding to one radiation detector 6. At this time, both radiation detectors 6D, 6E are faced to two γ-ray passages 11, (FIG. 2B). In conditions shown in FIGS. 2B and 2C, γ-rays from the γ-ray source 38 are incident upon the radiation detectors 6D, 6E, by a number of about N, respectively. Accordingly, with the use of the shied members 8, the γ-rays can be incident upon the radiation detectors by a number of about 4N. Thus, with the use of the collimator having a plurality of γ-ray passages 11 each having a cross-sectional area so as to face a plurality of radiation detectors 6D, 6E, the γ-rays are incident upon by a number larger than a number of γ-rays incident upon a collimator with γ-ray passages each having a cross-sectional area equal to that of a cross-sectional area of a radiation detector, the number being multiplied by about n which is equal to a ratio between the cross-sectional area of each of the γ-ray passages in the collimator and the cross-sectional area of each of the radiation detector. The cross-sectionals of both γ-ray passage and radiation detectors which are described in this specification are those in a direction orthogonal to the center axis of each of the γ-ray passages. The shield members 8 shown in FIG. 1A, have the γ-ray passages 11 each having a cross-sectional area which is four times as large as that of a single radiation detector 6, and accordingly, the sensitivity of detection of γ-rays is four times larges as that of the shield member 8D shown in FIG. 2C.

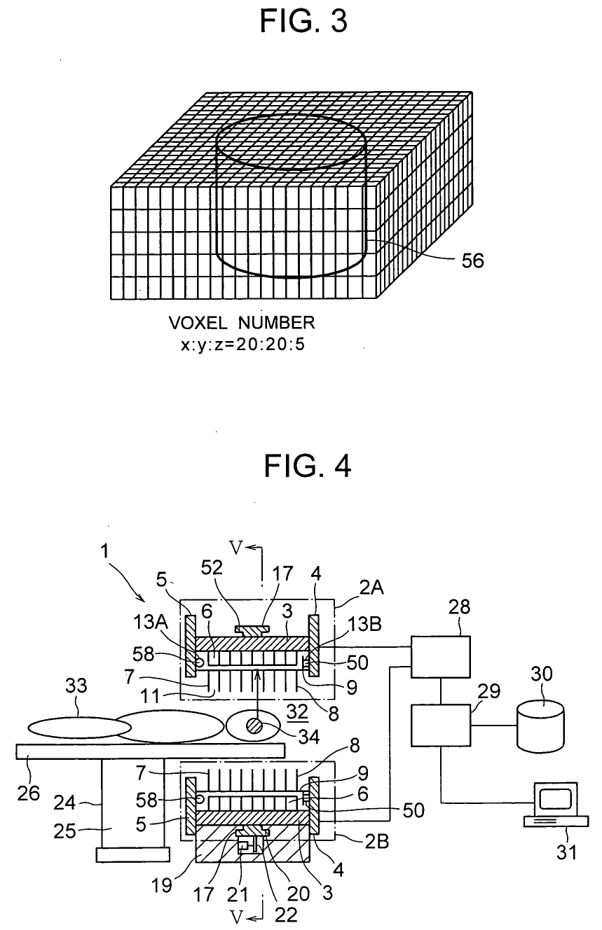

Simulation was made for the above-mentioned sensitivity so as to determine how statistic noise varies. In this simulation, it was estimated that the γ-ray source 38 was resembled to a cylindrical γ-ray source 56 having a homogeneous density as shown in FIG. 3, and single photons (γ-rays) were emitted from the γ-ray source 56. Further, it was also estimated that the detection efficiency of the radiation detector 6 was 100% for the sake of simplicity. With this configuration, a difference between an image which is created from γ-ray detection signals delivered by the radiation detector 6 with the use of the shield members 8 and an image created from γ-ray detection signals detected by the radiation detector 6 with the use of the shield members 8D in the conventional collimator was verified. 10. It was estimated that γ-rays radiated from the γ-ray source 56 by one billion cycle times in all random directions with an equal probability, and in this situation, the images were reconstituted. A coefficient of correlation between the reconstituted image and an ideal image (that is, an image obtained by dividing the γ-ray source 56 into the voxels) was evaluated. The definition of the coefficient of correlation is exhibited by the following formula (1)

Coefficient of Correlation={E(p.q)−E(p)E(q)}/(σₚ.σₚ) (1)

where p is a pixel value vector of each pixel in the ideal image, q is a pixel value vector of each pixel of the reconstituted image, σₚ is a standard deviation of the pixel value vector p, σ_{q} is a standard deviation of the pixel value vector q, and E(P.Q) is manipulation for obtaining an average of the pixel value vector p and the image value vector q. The calculation of the coefficient of correlation for the reconstituted image resulted as 0.824 in the case of the shield members 8 which should be compared with 0.577 in the case of the shield members 8D. That is, it was found that the image according to the present invention can approach a final state, faster than the conventional one, since the convergence of statistic noise in the present invention is faster than that of the conventional one. As a result, with the use of the shield members 8, the sensitivity of detection of the radiation detector 6 can be enhanced, and accordingly, the inspection time can be shortened, thereby it is possible to enable faster inspection for a person to be examined.

Next, explanation will be made of the reason why the collimator is displaced. For example, by successively displacing the shield members 8 as shown in FIGS. 1A, 1B and 1C, the range wherein γ-rays are incident upon the radiation detector 6 is changed. That is, the shield members 8 are displaced in such a way that the four side surface of the γ-ray passage 11 are positioned respectively on lines prolonged from the four side surfaces of each radiation detector 6 which are extended along the axial direction of the γ-ray passage. Such a displacement of the shield members 8 results in a configuration substantially equivalent to such a configuration that, for example, the radiation detector 6E is faced to a γ-ray passage having a cross-sectional area substantially equal to that of the single radiation detector 6E and formed in the collimator. As a result, in the case of displacement of the shield members 8, the spatial resolution of an tomogram created from γ-ray detection signals from the radiation detectors can be enhanced in comparison with the case of no displacement of the collimator constituted by the shield members 8. Further, the tomogram obtained in the case of displacement of the shield members 8 can have a spatial resolution which is equal to a tomogram created γ-ray detection signals given by using the shield members 8D each having a cross-sectional area equal to that of the radiation detector 6.

(Embodiment 1)

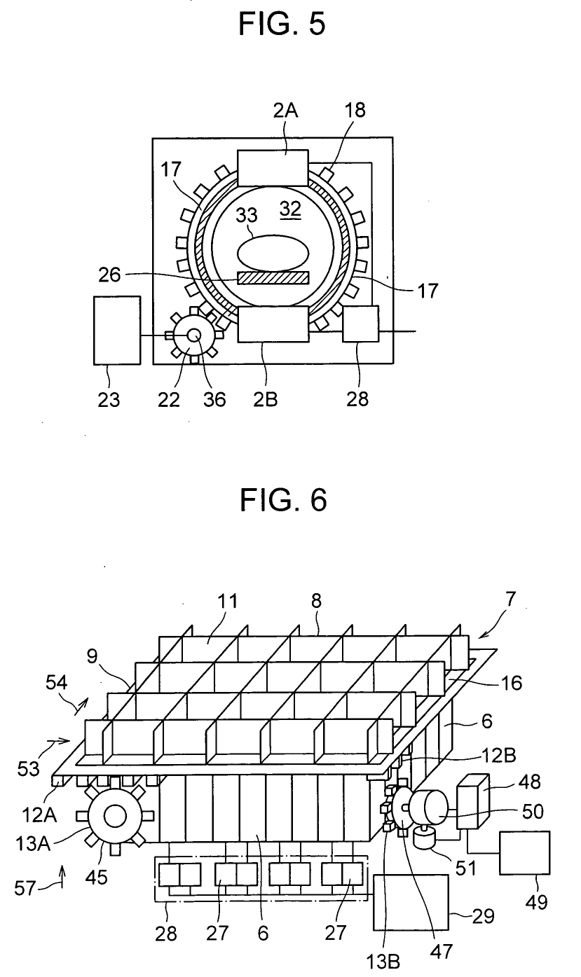

Explanation will be made of an radiographic inspection apparatus in a preferred embodiment of the present invention with reference to FIGS. 4 and 5.

The radiographic inspection apparatus 1 in this embodiment is composed of radiation detecting devices 2A, 2B, a device 24 for supporting a person to be examined, a signal processing device 28 and a tomogram forming device 29. Since the radiation detecting devices 2A, 2B have the same structure, explanation will be made of the structure of the radiation detecting devices as to the radiation detecting device 2A. The radiation detecting device 2A incorporates in its casing (indicated by the one-dot chain line) several radiation detectors 6, a collimator device 7 and collimator displacement device 13A, 13B. The support device 24 for a person to be examined has a support member 25 and a bed 26 located at the top end of the support member 25, being set on the support member 25 so as to be movable in the longitudinal direction thereof. The several radiation detectors 6 are arranged in a plurality of rows in the longitudinal direction of the bed 26 and are also arranged in a plurality of columns in a direction orthogonal to the longitudinal direction of the bed 26 and are held by a planar detector holding member 3. The radiation detectors 6 are semiconductor radiation detectors each having a semiconductor element part as a detecting part which has a 5 mm cube and which is made of cadmium tellurium (CdTe). The detecting part may be made of gallium arsenic (GaAs) or cadmium zinc telluride (CZT). A pair of the collimator holding members 4, 5 are attached to the detector holding member 3 at both ends thereof as viewed in the longitudinal direction of the bed 26.

The detector holding members 3 of the radiation detecting devices 2A, 2B are mounted at the inner surface of an annular coupling member 17 and are coupled to each other by the coupling member 17. Projections 52 formed being projected from the outer peripheral part of the coupling member 17 in the longitudinal direction of the bed 6 are engaged in a groove 20 formed in a support member 19 which is secured to the floor of an inspection room. The coupling member 17 can be moved circumferentially through the intermediary of the protrusions 20 which is guided in the guide groove 20. A motor 21 is located in a space defined in the support member 19 and is mounted to the latter. A pinion 22 is coupled to the rotary shaft 36 of the motor 21, and is meshed with a rack 18 formed in the outer peripheral surface of the coupling members 17.

The collimator device 7 incorporates, as shown in FIG. 6, a rectangular support frame 9, grid-like shield members 8 serving as a main body of a collimator and formed from a radiation shield material. The support frame 9 has rectangular through holes 16 so that it is attached to the collimator holding members, being movable in the longitudinal direction of the bed and a direction orthogonal thereto (the direction of the arrow 54), by a distance corresponding to at least one of the radiation detectors 6. The shield members 8 are positioned right above the through holes 6 and the ends thereof are secured to the support frame 9. The shield members 8 define a plurality of γ ray passages 11 serving as openings through which γ rays pass. Each of the γ ray passages 11 has a square cross-sectional area which is four times as large as the cross-sectional area of the radiation detector 6, similar to the γ ray passages 11 in the collimator 8A as stated above.

A rack 12A is attached to a lower surface (the surface on the side remote from the surface of the support frame 9 to which the shield members 8 are attached) of one of corners of the support frame 9 in the direction of the arrow 53 (the longitudinal direction of the bed). A rack 12B is provided to the lower surface of another one of corners of the support frame 9 in the direction of the arrow 54 (a direction orthogonal to the longitudinal direction of the bed). A pinion 45 and a pinion 47 are meshed with the rack 12A and the rack 12B, respectively. The pinion 45 and the pinion 47 are coupled to the rotary shafts of the motor 58 (FIG. 4) and the motor 50, respectively. The motor 50 is mounted on a motor moving device 51 mounted on the detector holding member 3. Although not shown, the motor moving device mounted thereon with the motor 58 is attached to the detector holding member 3. A collimator moving device 13A has the pinion 45, the motor 58 and the motor moving device (which is not shown) carried thereon with the motor 58. A collimator moving device 13B has the pinion 47, the motor 50 and the motor moving device 51. There is provided a control device 48 for controlling the starts and stops of the motor 50 and the motor moving device 51, and the starts and stops of the motor 58 and the motor moving device, Instead of the control device 48, there may be provided a control device for controlling the starts and stops of the motor 50 and the motor moving device 51, and a control device for controlling the start and stop of the motor 58 and the motor moving device provided thereon with the motor 58.

The motor moving device 51 for moving the motor 50 along the axial direction of the γ ray passage 11 is configured in such a way that for example a nut is provided to a distal end of a hollow rod attached to the motor 50, and a screw rod meshed with the nut is coupled to a rotary shaft of a motor (which is not shown) in the motor moving device 51 through the intermediary of a sped reducing mechanism. The nut is engaged with a detent member at its outer periphery and accordingly, is guided by the detent member in the axial direction of the γ ray passage 11. The motor moving member for moving the motor 58 has a configuration similar to that mentioned above.

The signal processing device 28 has a plurality of γ ray detection signal processing device 27 respectively connected to the corresponding radiation detectors, each being provided for each of the radiation detectors 6. The γ ray detection signal processing devices 27 are connected to a tomogram forming device 29 which are in turn connected to a memory device 30 and a display unit 31.

A person 33 to be examined through the SPECT is dosed into his human body with a radiopharmaceutical containing ⁹⁹Tc through injection. A radiopharmaceutical to be dosed may be selected in view of an inspection object (finding of a position of a cancer, inspection of an arterial stream and the like). The dosed radiopharmaceutical is accumulated in the affected part (for example, the affected part by a cancer) 34 in the person 33 to be examined. The person to be examined dosed with the radiopharmaceutical is kept on the bed 26. As the bed 26 travels, the person 33 to be examined is moved in an inspection space 32 defined between the radiation detecting device 2A and the radiation detecting device 2B. In such a case that the position of the affected part by a cancer has been known from a previous inspection, the affected part 34 is located within the inspection space 32.

γ rays emitted from the radiopharmaceutical accumulated in the affected part 34 pass through the γ ray passages 11 formed by the shield members 8 in the collimator device 7, and the through holes 16 formed in the support frame 9, and are then detected by the radiation detectors 6. The radionuclide contained in the radiopharmaceutical for the SPECT, is a single photon emission nuclide, and accordingly, a single γ ray emitted from the affected part 34 is radiated in one direction. The radiation detectors 6 deliver γ ray detection signals through detection of γ rays. The γ ray detection signals are delivered to the γ ray detection signal processing devices 27.

The γ ray detection signals delivered to the γ ray detection signal processing device 27 abruptly rise up, and thereafter, approach zero exponentially. Thus, they are subjected at first to wave-shaping which is made for smoothly processing the γ ray detection signals. The γ ray detection signals are converted into γ ray detection signals having a gauss distribution wave form. It is noted here that the γ rays emitted from the radiopharmaceutical scatter at a relatively high probability within the human body of the person 33 to be examined. The scattering γ rays which have been detected by the radiation detectors 6 have not positional information as to the affected part 34 in which the radiopharmaceutical is accumulated, but only have information as to scattering positions. These scattering γ rays as noise as to a specific position of the affected part are removed by the γ ray signals processing devices 27. That is, since the scattering γ rays have a low energy, they are removed by removing γ ray detection signals having an energy lower than a predetermined energy set value with the use of a filter, thereby it is possible to prevent the γ ray detection signal process devices 27 from counting the scattering γ rays.

The γ ray detection signals corresponding to γ rays which have been emitted from the radiopharmaceutical accumulated in the affected part 34 and which have not scattered in the human body (that is, non-scattering γ rays) have an energy higher than the above-mentioned energy setting value, and accordingly, they are not removed by the filer, and are therefore counted by the γ ray detection signal processing devices 27. The γ ray detection signal processing devises 27 adds positional data exhibiting positions of the radiation detectors 6 connected to the former, to the thus counted data, that is, the counted data and the position data are delivered. The tomogram forming device 29 receives therein the counted data and the position data of the radiation detectors 6 delivered from the γ ray detection signal processing devices 27, and stores these data in the memory device 30. Although detailed description thereto will be omitted, the tomogram forming device 29 creates a tomogram of the affected part 34 with the use of the counted data and the position data.

Next, detailed explanation will be made of the detection of γ rays emitted from the human body of the person 33 to be examined with the use of the radiation detecting devices 2A, 2B. Upon detection of the γ rays, the motor 21 is rotated so that the pinion 22 meshed with the rack 18 is rotated. With the rotation of the pinion 22, the coupling members 17 are moved circumferentially along the guide grooves 20 (The coupling members 17 are rotated). Accordingly, the radiation detecting devices 2A, 2B are turned around the person 33 to be examined laid on the bed 26, that is, around the bed 36. The radiation detectors 6 in the radiation detecting devices 2A, 2B can detect γ rays emitted in all directions from the person 33 to be examined with a high degree of efficiency.

Explanation will be made of the displacement of the collimator device 7 which is essential in this embodiment. The displacements of the collimator devices 7 provided in each of the radiation detecting devices 2A, 2B are identical with each other, and accordingly, the displacement of, for example, the radiation detecting device 2B will be explained. In the case of no replacement of the collimator device 7, the pinion 45 is disengaged from the rack 12A and the pinion 47 is also disengaged from the rack 12B. At this time, the shield members 8 in the collimator device 7 are positioned as shown in FIG. 1A. This condition continues for a T sec. In the case of detection of γ rays emitted from the person 33 to be examined, the affected part 34 in which the radiopharmaceutical is accumulated, corresponds to the γ ray source 38 shown in FIG. 2A which corresponds to FIG. 1A. Since the cross-sectional area of each of the γ ray passages 11 is greater than that of the γ ray passages 11B in the shield members 8D shown in FIG. 2C, the shield members 8 has a probability of blocking the γ rays, which is lower than that of the shield members 8D. Several γ rays passing through one of the γ ray passages 11 for a T sec., can be detected by either one of four radiation detectors 6 facing this γ ray passage.

After T sec., elapses, the collimator device 7, that is, in particular, the shield members 8, is displaced by a distance corresponding to one of the radiation detectors 6 in the direction of the arrow 53 until the state shown in FIG. 1B is obtained. Specifically, the motor moving device (which is not shown) is driven by a first pinion meshing control signal from the control device, so as to move the pinion 45 and the motor 58 toward the support frame 9 in the direction of the arrow 53 in order to mesh the pinion 45 with the rack 12A. Thereafter, the motor 58 is driven in response to a first frame moving control signal so as to rotate the pinion 45 in order to moved the support frame 9 in the direction of the arrow 53. Under control of the control device 48, the shield members 8 are displaced by a set distance (which corresponds to, for example, one of the radiation detectors 6) in the direction of the arrow 53, and thereafter, the pinion 45 and the motor 58 are moved in a direction reverse to the direction of the arrow 57, through the drive of the motor moving device in response to a pinion disengaging control signal from the control device 48. Thus, the pinion 45 is disengaged from the rack 12A. After the collimator device 7 comes into the state shown in FIG. 1B, for T to 2T sec., γ rays emitted from the person 33 to be examined are detected by the radiation detectors 6. Even after the collimator device 7 or in particular, the shield members 8 is displaced by a first set distance in the direction of the arrow 53 (comes into the state shown in FIG. 1B), the position of the collimator device 7 is only deviated, the shield members 8 are positioned on lines prolonged from the opposed surfaces of the adjacent radiation detectors 6 even in such a condition the position of the shield members 8 is deviated.

After 2T sec. elapses, the shield members 8 are displaced in the direction of the arrow 54 by a distance corresponding to one radiation detector 6 so as to come into the state shown in FIG. 1C. The motor moving device 51 is driven by a second pinion meshing control signal from the control device 48, and accordingly, the pinion 47 and the motor 50 are moved toward the support frame 9 in the direction of the arrow 54 so as to mesh the pinion 47 with the rack 12B. Thereafter, the motor 50 is driven in response to a second support frame moving control signal so as to rotate the pinion 47 in order to move the support frame 9 in the direction of the arrow 54. Under control of the control device 48, after the shield members 8 are displaced by a second set distance (corresponding to, for example, one radiation detector 6) in the direction of the arrow 54, the motor 50 and the pinion 47 is moved in a direction reverse to the direction of the arrow 57 through the drive of the motor moving device 51 in response to a pinion disengaging control signal from the control device 48. In this embodiment, the second set distance is equal to the first set distance. The pinion 47 is disengaged from the rack 12B. After the collimator device 7 comes into the condition shown in FIG. 1c, the radiation detector 6 detects γ rays emitted from the person to be examined. After the collimator device 7 or in particular, the shield members 8 are displaced by the second set distance in the direction of the arrow 54 (comes into the state shown in FIG. 1C), only the position of the collimator device 7 is deviated, and accordingly, the shield members 8 are located on lines prolonged from the opposed surfaces of the adjacent radiation detectors 6 even in this position deviated condition.

The widths of the racks 12A, 12B (the widths in the longitudinal direction of teeth formed in the racks) are greater than the width of one radiation detector 6 in cross-section having a square cross-section. Thus, even though the collimator device 7 is displaced by a distance corresponding to one radiation detector 6 in the direction of the arrow 54, the pinion 45 can be meshed with the rack 12A. Further, even though the collimator device 7 is displaced by a distance corresponding to one radiation detector 6 in the direction of the arrow 54, the pinion 47 can be meshed with the rack 12B.

By the displacement of the collimator device 7 as stated above, a condition equivalent to a condition in which the radiation detectors 6 respectively face the γ ray passages each having a cross-section substantially equal to the cross-section of one of the radiation detector. The memory device 49 stores control data required upon delivery of each of control signals from the control device 48.

After a lapse of 3T sec., for example, through an operation reverse to the displacement of the collimator device 7, the collimator device 7 is returned into the state shown in FIG. 1A. That is, the pinion 47 meshed with the rack 12B is rotated so as to move the support frame 9 in a direction reverse to the direction of the arrow 54 by a distance corresponding to one radiation detector 6. Thereafter, the rack 12A and the pinion 47 are disengaged from each other, and then, the rack 12A is meshed with the pinion 54. Due to the rotation of the pinion 45, the support frame 9 is moved by one radiation detector 6 in a direction reverse to the direction of the arrow 9.

In this embodiment, the displacements of the collimator devices 7 in the radiation detecting devices 2A, 2B are repeated as successively shown in FIGS. 1A, 1B and 1C by every T sec. while the radiation detecting devices 2A, 2B are rotated around the person 33 to be examined. In these conditions containing a condition in which the collimator devices 7 are on displacement, the radiation detectors 6 included in the radiation detecting devices 2A, 2B detect corresponding γ rays, and the γ ray detection signals delivered from the radiation detectors 6 are processed as stated above.

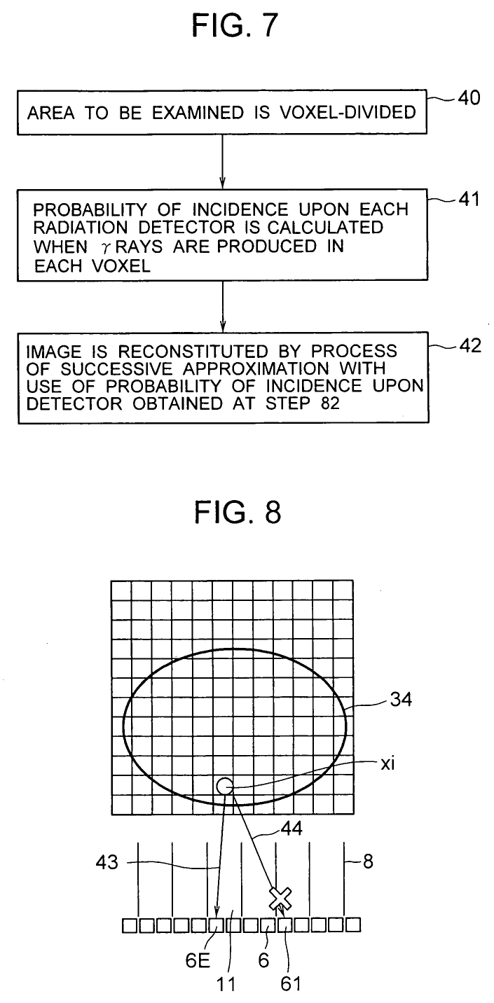

The tomogram forming device 29 which has received output data from the γ ray detection signal processing devices 27 stores output data (counted data and position data) in the memory device 30. The tomogram forming device 29 creates a tomogram through process steps shown in FIG. 7. The creation of this tomogram will be hereinbelow explained in detail. The tomogram in this embodiment is created with the use of an iterative process which is disclosed in Medial Technology Vol. 18, No. 1, pages 40 to 45, and OS-EM or a coordinate descent process may be used as the iterative process. The above-mentioned process steps using the iterative process will be explained with reference to FIG. 7.

At first, the human body of the person 33 to be examined is voxel-divided (step 40). The manner of the division is optional, but in this embodiment, as shown in FIG. 8, the human body is divided into m voxels in a grid-like pattern. As shown in FIG. 3, the voxels are cubic. The voxels are denoted by x, that is, the i-th voxel is denoted by xᵢ. Further, in this embodiment, a number N₀ of the radiation detectors 6 are provided in each of the radiation detecting devices 2A, 2B. The radiation detecting devices 2A, 2B are stopped at P times for detecting γ rays (image-picked up) during a half turn of each of the radiation detecting devices 2A, 2B around the person 33 to be examined, and further, if K kinds of collimator patterns are present due to displacement of the collimator device 7 for P-times of the image pick-up, it is estimated that the total number of detecting position patterns for detecting γ rays emitted from the person 33 to be examined is P×K×N₀ so that a number of γ rays which are incident upon the radiation detectors 6 in a detecting position pattern j (j is value among 1 to P×K×N₀) is yᵢ.

Next, a probability of incidence of γ rays upon each radiation detector when γ rays are produced in each voxel will be calculated (step 41). The probability of incidence of γ rays is a probability of γ rays which are produced in a voxel xᵢ and reach the radiation detector yᵢ. In other words, the probability of incidence of γ rays is an element aᵢⱼ in a projection matrix A. The probability of incidence can be determined in dependence upon a shape of the shield members 8 in the collimator device 7, a position of a radiation detector 6, a displacement pattern of a radiation detector 6, a size and a shape of a voxel and a shape of the person 33 to be examined. A way of determining a probability of incidence will be explained below.

At first, in a condition in which a turn of the radiation detector is at p-th time, and γ rays are incident upon an n-th radiation detector in a k-th displacement pattern, if the series j is given by ((p−1)×k×N₀+n), a probability aᵢⱼ with which γ rays produced in the voxel i are incident upon a series j of the radiation detector 6 is exhibited by the following formula:

aᵢⱼ=Ω×χ×μ

where Ω is a solid angle occupied by the radiation detector 6 in the series j as viewed from the voxel i (area of radiation detector in series j as viewed from voxel i)/(outer spherical surface having a radius equal to a distance between voxel i and detector in series j (determined by p, n), depending upon i, p, n), χ is a blocking rate of γ rays by the collimator device 7, and μ is an attenuation rate of γ rays in the human body of the person 33 to be examined. A more specific example will be explained with reference to FIG. 8. In such a case that γ rays 43 produced from a voxel xᵢ within the affected part 34 is incident upon an n-th radiation detector 6E whose turn is p through the γ ray passages 11 defined by the shield members 8 with a moving pattern k of the collimator device, a probability aᵢⱼ of incidence of γ rays which are produced in the voxel xᵢ and which are incident upon the radiation detector 6 in a series j (=((p−1)×K×N₀+(K−1×No+n) is χ=1 due to no affection by the collimator device 7. Thus, a probability aᵢⱼ of incidence of γ rays which are produced from the voxel i and which are incident upon the radiation detector 6 in the j series is exhibited by the following formula:

aᵢⱼ=Ω×μ

where Ω is a solid angle determined by i, p, n and μ is an attenuation rate in the the person 33 to be examined. Meanwhile, in such a case that the γ rays 44 produced in a certain voxel xᵢ are attenuated and absorbed by the shield members 8 in the collimator device 7, that is, they are not incident upon, for example, a (j+1)-th radiation detector 6F, χ=0 is obtained, and accordingly, the series value as to the radiation detector 6F at a (j+4)-th position is given by (=((p−1)×K×N₀+(K−1×Nₒ+n+4)=n+4), and accordingly, a probability aᵢⱼ₊₄ of incidence of γ rays produced in the voxel xᵢ is exhibited by

aᵢⱼ₊₄=0

Thus, aᵢⱼ for every radiation detector 6 is obtained. It is noted here that the solid angle Ω and the blocking rate χ of γ rays are dependent upon a sequence of image-pick-up and a shape of the device while the attenuation rate μ of γ rays is dependent upon the person 33 to be examined. Incidentally, affection by another factor should be taken into consideration as necessary when this probability aᵢⱼ is obtained. Thus, if a sequence of image pick-up is identical with one and the same device, the blocking rate χ of γ rays and the solid angle Ω are not altered. Accordingly, for example, the value of Ω×χ may be previously calculated and stored in the memory device 30.

A tomogram of the person 33 to be examined is created (step 42) with the use of the counted data and the probability of incidence upon the radiation detector 6 obtained at step 41. At this step, a tomogram including the affected part 34 is also created. The reconstitution of the tomogram in this embodiment can be made by a process of successive approximation. With the use of the projection matrix A in which vectors y of the counted data (counted number of γ rays) obtained from the γ ray detection signal processing devices 27 and the probabilities obtained at step 41 are arrayed, a γ ray production number vector x in each voxel is exhibited by the following formula:

Ax=y (2)

where A is a matrix in which the probabilities aᵢⱼ are arrayed although it is duplicate. The vector x is a value of γ ray produced at each voxel, and is to be obtained by iterative calculation which will be explained later. The vector x becomes substantially zero outside of the person 33 to be examined but becomes a substantially constant value in the person 33 to be examined in an example in which the vector x is obtained after iterative calculation but it becomes higher than the constant value in the affected part 34 or a specific internal organ. Accordingly, diagnosis of a neoplasm can be made from a value where the value of the vector x is high. Meanwhile, the vector y is a counted number of γ rays which has been obtained with the use of output signals from the radiation detectors 6. The value thereof becomes substantially zero in the case of a radiation detector 7 located at a position where no γ rays produced in the human body of the person 33 to be examined can be incident upon, in view of a positional relationship among, for example, the person 33 to be examined, the radiation detector 6 and the collimator device 7. As the probability of incidence from the human body is higher and as data from a radiation detector 6 is obtained from a position where a body part upon which γ rays are incident is larger, the value of the vector y becomes larger. Through calculation with the use of formula (2), with the use of a production number xᵢ which has been calculated in each voxel, image data of the above-mentioned tomogram is obtained.

(1) In this embodiment, a cross-sectional shape of each of the γ ray passages 11 is greater than that of each of the radiation detectors 6 (specifically, the cross-sectional area of each of the γ ray passages 11 is substantially equal to the total cross-sectional area of four radiation detectors 6 which are arranged in a square shape), and accordingly, γ rays which is incident upon each radiation detector 6 can be enhanced. This causes an increase in sensitivity of detection of γ rays in the radiation detectors 6 in this embodiment, thereby it is possible to greatly shorten the inspection time for the person 33 to be examined.

(2) In this embodiment, the collimator device 7 is displaced in the directions of the arrows 53 and 54 by the collimator moving device, there can be formed such a configuration that a single radiation detector 6 is faced to a γ ray passage having a cross-sectional area substantially equal to that of the radiation detector 6. Thus, the spatial resolution of a tomogram which is obtained by using the data obtained from γ ray detection signals delivered from the radiation detectors 6 is remarkable enhanced in comparison with such a configuration that the collimator device 7 is not moved, and accordingly, a spatial resolution substantially equal to a special resolution which is obtained by a conventional collimator as shown in FIG. 2C can be obtained while the special resolution of the tomogram including the affected part 34 can be enhanced.

(3) In this embodiment, the grid parts of the shield members 8 are successively positioned on lines prolonged from four side surfaces faced in the axial direction of the γ ray passage 11 (the states shown in FIGS. 1A, 1B and 1C), and the displacement of the collimator device 7 can be simply carried out by the control device 48. In particular, since three displacement states (shown in FIGS. 1A, 1B and 1C) of the shield members 8 can be carried out at predetermined time intervals, the radiation detectors 6 experiences the respective states at the same time intervals. This facilitates the calculation of the probability of incidence for each of detections of radiation.

(4) In this embodiment, the collimator holding members 4, 5 are located around the radiation detectors in a group within each of the radiation detecting devices 2A, 2B (the radiation detecting devices in a group are located between the collimator holding members 4, 5), and accordingly, the radiation detectors 6 can be uniformly arranged in comparison with such a configuration that collimator holding members are located among radiation detectors 6. Thus, due to several symmetries including a lateral symmetry of the detectors, a certain regularity can be found for values of Ω and χ in the projection matrix A. As a result, a volume of data to be stored in the memory device 30 can be reduced with the use of the regularity.

(5) In this embodiment, the collimator holding members 4, 5 are located around the radiation detectors 6 in a group, and accordingly, γ rays which are incident upon the radiation detectors 6 can be prevented from being blocked by the collimator holding members.

(6) The collimator devices 7 are held by the collimator holding members 4, 5, and accordingly, the collimator devices 7 on moving can be stably held.

(7) In this embodiment, the pinion 47 and the rack 12B are disengaged from each other when the collimator devices 7 are displaced in the direction of the arrow 53, and accordingly, it is possible to eliminate abrasion caused by chaffing between the rack 12B on moving and the pinion 47 which is not moved, during moving in the direction of the arrow 53. Further, in this embodiment, the pinion 45 and the rack 12 are not meshed with each other when the collimator device is moved, and accordingly, it is possible to eliminate abrasion caused by chaffing between the rack 12A on moving and the pinion 45 which is not moved during moving in the direction of the arrow 54.

(8) In this embodiment in which the collimator devices 7 are displaced in the directions of the arrows 53, 54, the time required for the reconstitution of the tomogram can be shortened in comparison such a case that the collimator devices are rotated as in an embodiment 3 which will be explained later.

(Embodiment 2)

Explanation will be hereinbelow made of an embodiment 2 of the present invention. The radiographic inspection apparatus in this embodiment has the same configuration as that of the radiographic inspection apparatus 1 as stated above, except that the motor moving device for moving the motor for rotating the pinion 45, and the motor moving device 51 are eliminated from the radiation detecting devices 2A, 2B. Thus, in the radiographic inspection apparatus in this embodiment, the rack 12A and the pinion 45 and further the rack 12A and the pinion 47 are always meshed with each other. When the collimator devices are displaced in the direction of the arrow 53, the rack 12B slides between teeth of the pinion 47 while when the collimator devices are displaced in the direction of the arrow 54, the rack 12A slides between the teeth of the pinion 45. The motor 58 and the motor 50 are laid on the collimator holding members 4, 5.

In this embodiment, the advantages (1) to (6) obtained in the embodiment 1 can be also obtained. Further, in this embodiment, the motor moving devices are not required, and accordingly, the structure thereof can be simplified in comparison with that of the embodiment 1.

Although it has been explained that the collimator devices 7 are displaced in a direction crossing the center axis of each of the γ ray passages 11 in the embodiments 1 and 2, the collimator devices 7 may be fixed to the collimator holding members 4, 5 while two radiation detector moving devices are provided, instead of the collimators moving devices 13A, 13B so that all radiation detectors 6 are moved together in the direction of the arrows 53, 54. That is, moving tables are provided to the radiation detector holding members 3 so as to be movable in the directions of the arrows 53, 54, and all radiation detectors 6 are laid on the moving tables. Further, the moving tables are moved in respective predetermined directions by the two radiation detector moving devices. With this configuration, the above-mentioned advantages (1) and (3) can be also obtained. However, in the case of moving the radiation detectors 6, it is required to lay signal transmission lines communicating between the radiation detectors 6 and the γ ray detection signal processing devices 27 so as to prevent the movement of the radiation detectors 6 from being hindered, and accordingly, the laying of the signal transmission lines becomes complicated in comparison with the embodiments 1 and 2. In other words, the laying of the signal transmission lines is simple. It is noted that the tomogram forming device 29 creates a tomogram of the person 33 to be examined by process steps similar to those in the embodiment 1.

(Embodiment 3)

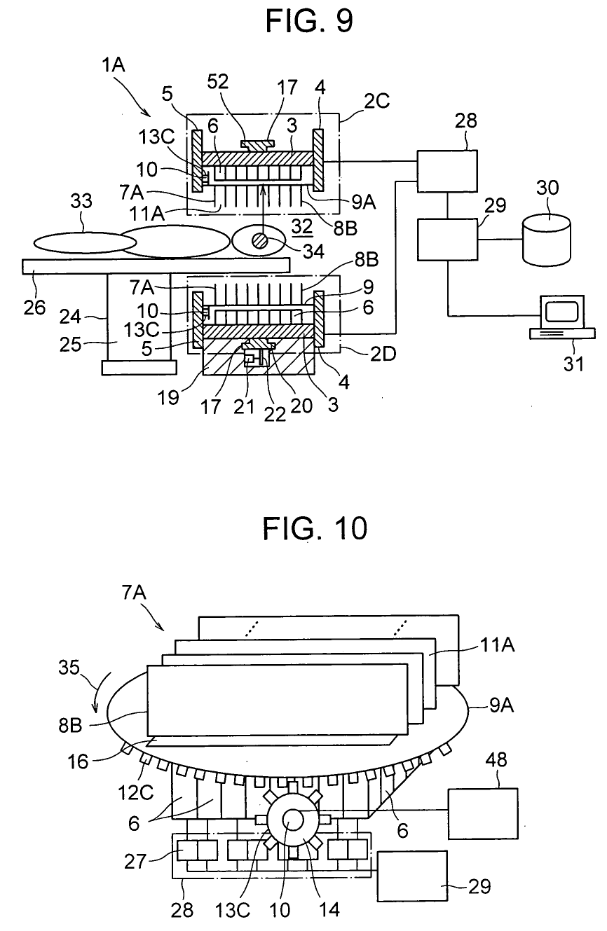

Explanation will be hereinbelow made of a radiographic inspection apparatus in a third embodiment with reference to FIGS. 9 and 10. The radiographic inspection apparatus in this embodiment has the same configuration as that of the radiographic inspection apparatus in the embodiment 1, except that radiation detecting device 2C, 2D are used instead of the radiation detecting devices 2A, 2B. The radiation detecting devices 2C has the same configuration as that of the radiation detecting device 2D, only the radiation detecting device 2C will be explained.

The radiation detecting device 2C incorporates, within a casing (which indicated by a one-dot chain line), several radiation detectors 6, a collimator device 7 and a collimator moving device 13C. The configuration of the radiation detecting device 2C is the same as that of the radiation detecting device 2A, except the collimator device 7A and the collimator moving device 13C. The collimator device 7A incorporates, as shown in FIG. 10, a circular support frame 9A and planar shield members 8B which is a collimator body and which is made of a radiation shield material. The support frame 9A has rectangular through holes 16, and is attached to collimator holding members 4, 5 so as to be rotatable circumferentially of the support frame 9A. γ ray passages 11A through which γ rays pass are defined among the shield members 8B. A width between the shield members 8, that is, a width of each of the γ ray passages 11A is equal to the width of the cross-section of one of the radiation detectors 6. Further, the length of each of the γ ray passages 11A along the longitudinal direction of the shield members 8B is equal to the total sum of the all radiation detectors 6 located between the shield members 8. A rack 12C is arranged in a ring-like shape along the peripheral part of the support frame 9A at a surface on the side remote from a surface onto which the shield members 8b are attached. A pinion 14 coupled to a motor 10 is meshed with the rack 12C. The motor 10 is mounted on the collimator holding member 5. The collimator moving device 13C has the motor 10 and the pinion 14.

The person 33 to be examined who is dosed with a radiopharmaceutical containing ⁹⁹Tc through injection into his human body is positioned in an inspection space 32 after movement of a bed 26. The person 33 to be examined is diagnosed through SPECT. γ rays emitted from the radiopharmaceutical accumulated in the affected part are radiated from the person 33 to be examined, passing through the γ ray passages 11A in the collimator device 7A and the through holes 16, and are detected by the radiation detectors 6. γ ray detection signals delivered from the radiation detectors 6 are delivered to the γ ray detection signal processing devices 27. A tomogram forming device 29 creates a tomogram of the affected part 34 with the use of counted data and positional data of the radiation detectors 6.

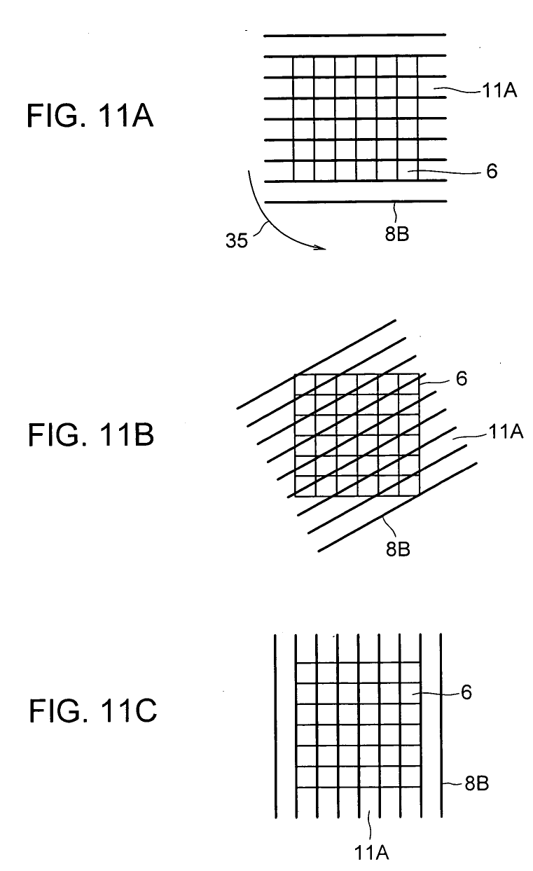

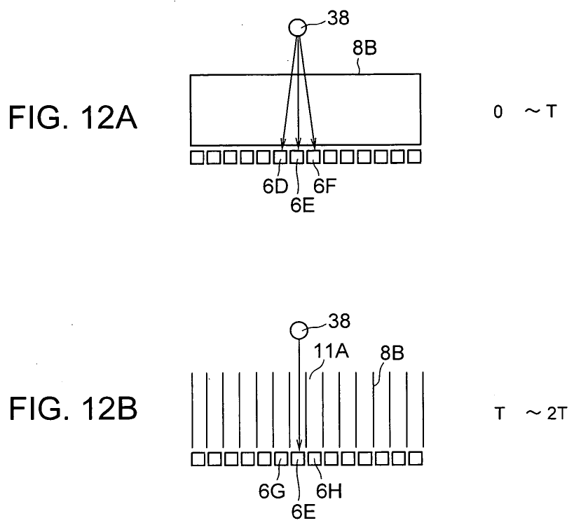

The displacements of the collimator devices 7A provided in the radiation detecting devices 2C, 2D have the same configuration, and accordingly, the displacement of only the collimator device 7A in the radiation detecting device 2D will be explained as an example. At first, the collimator device 7A is in a state shown in FIG. 11A, which continues for T sec. In the state shown in FIG. 11A, the longitudinal direction of the shield members 8B is parallel with the longitudinal direction of the bed 26, and the shield members 8B is positioned right above a certain side surface of a radiation detector 6. γ rays emitted from a γ ray source 38 (which corresponds to the affected part 34) as shown in FIG. 12A corresponding to FIG. 11A, are detected by the radiation detectors 6D, 6C, 6F and the like after passing through one of the γ ray passages 11A.

After T sec, elapses, the motor 10 is rotated in response to a support frame turning control signal transmitted from the control device 48, that is, in response to a support frame moving control signal, so as to rotate the pinion 14. The support frame 9A having the rack 12C meshed with the pinion 14 is rotated. Thus, the collimator device 7A comes into a state shown in FIG. 11C by way of a state shown in FIG. 11B, that is, it comes into such a state that the longitudinal direction of the shield members 8B become orthogonal to the longitudinal direction of the bed 26, and accordingly, the shield members 8B is positioned right above another side surface of the radiation detector 6. In the state shown in FIG. 11C, γ rays radiated from the person 33 to be examined are detected by the radiation detectors 6 in the radiation detecting devices 2C, 2D in T to 2T sec. γ rays emitted from the γ ray source 38 pass through a single γ ray passage 11A and are then detected by the radiation detector 6E. γ rays emitted from the γ ray source 38 are inhibited from being incident upon the radiation detectors 6G, 6H by means of two shield members 8B adjacent to the γ ray passage 11. In this embodiment, the rotation or the displacement of the collimator devices 7 in the radiation detecting devices 2C, 2D from the state shown in FIG. 11A to the state shown in FIG. 11C are repeated at every T sec.

In this embodiment, the tomogram forming device 29 creates a tomogram of the person 33 to be examined through the process steps shown in FIG. 8, similar to the embodiment 1.

This embodiment can exhibit the advantages (1) to (6) exhibited by the embodiment 1.

Even in the embodiment 3, the collimator device 7 is fixed to the collimator holding members 4, 5 while all the radiation detectors 6 are rotated by means of the radiation detector moving device in a direction crossing the center axis of each of the γ ray passages 11A, instead of the rotation of the collimator devices 7A in the crossing direction. Even with this configuration, the advantages (1) and (2) may be obtained. However, laying of the above-mentioned signal transmission line becomes complicated.

According to the present invention, there can be provided a radiographic inspection apparatus which can shorten the inspection time and can enhance the spatial resolution of thus obtained image.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A radiographic inspection apparatus incorporating a collimator device in which a plurality of radiation passages are defined, a plurality of radiation detectors for detecting radiation rays passing through the radiation passages, and a moving device for moving either the plurality of radiation detectors or the collimator device in a direction crossing the center axis of each of the radiation passages, characterized in that each of the radiation passage has a cross-sectional area in the crossing direction, is greater than that of each of the radiation detectors in that direction.

2. A radiographic inspection apparatus as set forth in claim 1, further including a tomogram forming device for creating a tomogram by using data obtained from radiation detection signals delivered from the plurality of radiation detectors.

3. A radiographic inspection apparatus as set forth in claim 1, further including a control device for controlling the moving device.

4. A radiographic inspection apparatus as set forth in claim 1, further including a rotating device for rotating the radiation detecting device around a bed on which a person to be examined is laid.

5. A radiographic inspection apparatus as set forth in claim 1, wherein the collimator device is movably attached to a pair of collimator holding members provided in the radiation detecting device.

6. A radiographic inspection apparatus as set forth in claim 5, wherein all radiation detectors are arranged between the pair of collimator holding members.

7. A radiographic inspection apparatus incorporating a collimator device in which a plurality of radiation passages are defined, a plurality of radiation detectors for detecting radiation rays passing through the radiation passages, and a collimator moving device for moving either the plurality of radiation detectors or the collimator device in a direction crossing the center axis of each of the radiation passages, characterized in that the plurality of radiation detectors are faced to the respective radiation passages.

8. A radiographic inspection apparatus as set forth in claim 1, further including a tomogram forming device for creating a tomogram by using data obtained from radiation detection signals delivered from the plurality of radiation detectors.

9. A radiographic inspection apparatus as set forth in claim 7, further including a control device for controlling the moving device.

10. A radiographic inspection apparatus as set forth in claim 7, further including a rotating device for rotating the radiation detecting device around a bed on which a person to be examined is laid.

11. A radiographic inspection apparatus as set forth in claim 7, wherein the collimator device is movably attached to a pair of collimator holding members provided in the radiation detecting device.

12. A radiographic inspection apparatus as set forth in claim 11, wherein all radiation detectors are arranged between the pair of collimator holding members.

13. A radiographic inspection apparatus comprising:
a radiation detecting device including a collimator device having shield members defining a plurality of radiation passages, a plurality of radiation detectors for detecting radiation rays passing through the radiation passages, and a moving device for moving the collimator device,
a control device for controlling the moving device so as to displace the shield members from a position on a line prolonged from a certain side surface of each of the radiation detectors to a position on a line of another side surface of the radiation detector, and
a tomogram forming device for creating a tomogram by using data obtained from radiation detection signals as outputs from the radiation detectors, characterized in that each of the radiation passages has a cross-sectional area in the crossing direction is greater than that of each of the radiation detectors in that direction.

14. A radiographic inspection apparatus as set forth in claim 13, wherein the radiation detecting device includes a rotating device for rotating the radiation detecting device around a bed on which a person to be examined is laid.

15. A radiographic inspection apparatus as set forth in claim 13, wherein the collimator device is movably attached to a pair of collimator holding members provided in the radiation detecting device.

16. A radiographic inspection apparatus as set forth in claim 15, wherein all radiation detectors are arranged between the pair of collimator holding members.

17. A radiographic inspection apparatus as set forth in claim 13, wherein radiation detection signal processing devices receiving radiation detection signals from the radiation detectors, for delivering the data are provided each for each of the radiation detectors.

18. A radiographic inspection apparatus incorporating a collimator device in which a plurality of radiation passages are defined, a plurality of radiation detectors for detecting radiation rays passing through the radiation passages, and a moving device for moving the plurality of radiation detectors and the collimator device, relative to each other in a direction crossing the center axis of each of the radiation passages, characterized in that each of the radiation passage has a cross-sectional area in the crossing direction, is greater than that of each of the radiation detectors in that direction.

19. A radiographic inspection method with the use of a radiographic inspection device incorporating a plurality of radiation detectors, and a collimator device in which a plurality of radiation passages are defined, each of the radiation passages has a cross-sectional area in a direction crossing a center axis of each of the radiation passages is greater than that of each of the radiation detectors in that direction, characterized in that
the plurality of radiation detectors detect radiation rays passing through the radiation passages, and
either the plurality of radiation detectors or the collimator device is moved in a direction crossing the center axis of the radiation passage.

20. A radiographic method as set forth in claim 19, wherein the radiation detecting device is rotated around a bed on which an object to be examined is laid.

21. A radiographic method as set forth in claim 19, wherein a tomogram is created from data obtained from the plurality of radiation detectors.

22. A radiographic method as set forth in claim 20, wherein a tomogram is created from data obtained from the plurality of radiation detectors.
